(19) United States
(12) Patent Application Publication
(10) Pub. No.: US 2012/0078725 A1
(43) Pub. Date: Mar. 29, 2012

(54) METHOD AND SYSTEM FOR CONTEXTUAL ADVERTISEMENT RECOMMENDATION ACROSS MULTIPLE DEVICES OF CONTENT DELIVERY

(75) Inventors: Anutosh Maitra, Bangalore (IN); Sanjoy Paul, Bangalore (IN); Kumar Hemant, Muzaffarpur (IN); Saurabh Sirolia, Ujjain (IN)

(73) Assignee: INFOSYS TECHNOLOGIES LIMITED, Bangalore (IN)

(21) Appl. No.: 13/070,701

(22) Filed: Mar. 24, 2011

(30) Foreign Application Priority Data
Sep. 27, 2010 (IN) 2826/CHE/2010

(51) Int. Cl. G06Q 30/00

(52) U.S. Cl. 705/14.66

(57) ABSTRACT

The present invention includes a method and a system for recommending at least one advertisement to a user. The recommendation is provided based on the interaction with at least two devices. The user is identified when an interactive session is initiated by the user on a device of the at least two devices. Thereafter, a contextual profile of the identified user is selected from a database. The contextual profile is associated with one or more contextual sub-profiles. Further, each contextual sub-profile is associated with a corresponding device. Furthermore, one or more contextual attributes are dynamically captured from the interactive session. Thereafter, at least one of the contextual profile and the captured contextual attributes is mapped with a plurality of pre-stored advertisements. Subsequently, at least one advertisement is suggested on the device based on the mapping.

### FIELD OF THE INVENTION

The present invention relates, in general, to targeted advertisements. More specifically, the invention relates to delivering contextual advertisements across multiple devices of content delivery.

### BACKGROUND OF THE INVENTION

As various businesses are being frequently introduced into the market, the need for brand promotion and marketing is increasing at an exponential rate. Conventionally, businesses adopt television-based “identical” advertising system to reach out to potential customers for selling their products and services. The “identical” system displays identical advertisements to every customer at a given instance of time without seeking feedback on the displayed advertisements.

Businesses are nowadays exploring online advertising as a major tool to garner revenue and increase brand equity, considering the far reach of the Internet. Broadly, the online advertising encompasses multiple advertising means, including sending advertisements via e-mails, displaying transactional advertisements (coupons, vouchers) on a publisher's website, sending advertisements based on a customer's past click stream, and the like.

Various examples of online advertising, such as a “random” system, and a “rule-based” system are described below.

Random System

The “random” system displays arbitrary advertisements and does not take into account the interests of the customers. Pursuant to this, irrelevant advertisements are pushed to the disinterested customers, thereby leaving a negative impact. For example, when the customers download music files, random advertisements related to screensavers get displayed to the customers.

Rule-Based System

The “rule-based” system takes into consideration a static profile of a customer that is obtained earlier. For example, when the customer fills a registration form while creating an e-mail account, the information populated in the form may constitute the static profile of the customer. The information includes age, income, job-profile, address, and the like. Further, even though the “rule-based” system is more effective than the “random” systems, the correctness of the information included in the static profile degrades over the time. Therefore, considerable efforts are required to regularly update the static profile.

The “random” and “rule-based” systems described above also suffer from advertisement fatigue because of repeatedly presenting the same advertisements, or the advertisements from similar genre, to the customer. Another shortcoming is that these systems do not consider the interests exhibited by the customer before transmitting the advertisements. However, the biggest limitation is that these advertisement systems are restricted to only one device of content delivery.

There are newer advertisement systems, such as “collaborative” system, “content-based filtering” system, and “usage-mining” for recommending advertisements to the customers. These advertisement systems are explained below.

Collaborative System

The “collaborative” system selects the advertisements based on the ratings provided by customers. A group of like-minded customers are selected for providing ratings to different types of advertisements. Based on the ratings, suitable advertisements are sent across to the customers. However, collecting a web-based rating or survey-based customer rating for an advertisement requires careful planning. The planning requirement is in terms of identifying the right customers for rating, allocating time to them for rating and synchronizing it with marketing efforts. This system results are not readily available in light of the effort intensive planning phase, time allocated to customers for rating, and delayed rating results because of non-responsive customers. Further, a scalability limitation arises when the number of customers and the advertisements become large.

Content-Based Filtering System

The “content-based filtering” system learns the interest exhibited by a customer on web contents. Next, the interest of the customer on unseen web contents is anticipated on the basis of content similarity. The “content-based filtering” system supports contextual advertisements in which advertisements are displayed based on the context of the web content. In other words, the advertisement rendered on the web content holds relevance to the displayed content. Relevant advertisement may also be rendered by anticipating the customer's interest based on search words entered by the customer on the web. However, the process of anticipation is difficult owing to the inherent difficulty in determining the semantic similarity among multiple contents.

Usage-Mining System

The “usage-mining” system selects advertisements based on the historic record of customer's browsing activities. The system uses machine learning and one or more statistical techniques on the record of customer's browsing activities for the selection of advertisements. Therefore, there is no need for the customer to provide his inputs, such as ratings, or information for static profile. The “usage-mining” system is based on the historical behavior of the customer, and does not take into account the real time contexts such as a current location of the customer and his current activity.

A biggest limitation of the “collaborative”, “content-based filtering”, and “usage-mining” systems is that each of these systems is best suited for advertising on one type of content delivery devices. A few types of content delivery devices are mobile-phones, computers, radio, and television. In addition, examples of content include audio files, video files, text, and the like.

Further, the interest exhibited by a customer is generally different on different types of devices. This is not considered by these systems while displaying advertisements. To illustrate the aforementioned limitations, let us consider that the customer prefers watching a movie on a desktop device, while he/she prefers to surf loan websites on a mobile device. Therefore, if deployed for the desktop devices, these systems will only display advertisements pertaining to movies. Similarly, if these are set up for mobile devices, the systems will only display loan advertisements to the customer. There is no provision of using the knowledge regarding customer's interest from one device for advertising on another device. Therefore, cross-device knowledge sharing is not supported by these systems. Further, these systems also do not take into account that all the devices are not characterized to support similar content. For example, a customer may prefer to watch a football match on a television as compared to a mobile handset due to greater clarity and resolution. Similarly, the customer may find it more convenient to send a message by the mobile handset as compared to a computer.

In light of the above discussions, there is a need for a method and a system for delivering contextual advertisements by evaluating the interests of the customer across multiple devices of content delivery. Further, there is a need for dynamically capturing change in the customer's interest over a period of time.

### BRIEF SUMMARY OF THE INVENTION

The present invention includes a method for recommending at least one advertisement to a user. The recommendation is provided based on the interaction with at least two devices. The user is identified when an interactive session is initiated by the user on a device of the at least two devices. Thereafter, a contextual profile of the identified user is selected from a database. The contextual profile is associated with one or more contextual sub-profiles. Further, each contextual sub-profile is associated with a corresponding device. Furthermore, one or more contextual attributes are dynamically captured from the interactive session. Thereafter, at least one of the contextual profile and the captured contextual attributes is mapped with a plurality of pre-stored advertisements. Subsequently, at least one advertisement is suggested on the device based on the mapping.

The present invention further describes a method for preparing a contextual profile that is utilized for recommending at least one advertisement to a user.

The recommendation is provided based on the user's interaction with at least two devices. First, static information of the user is captured. Next, one or more contextual attributes are dynamically captured from the at least two devices. Further, at least one contextual attribute is captured over a pre-defined time period. A contextual sub-profile is created for each device based on the static information and the captured contextual attributes. The contextual profile of the user is then created by collating each of the contextual sub-profiles.

The present invention also describes a system for recommending at least one advertisement to a user. The recommendation is provided based on the interaction between the system and at least two devices. A data capturing module is configured for dynamically capturing one or more contextual attributes from an interactive session. The interactive session is initiated by the user on a device of the at least two devices. The system also includes a recommendation module that further includes a selecting module, a mapping module, and a suggestion module. The selecting module selects a contextual profile from a database. The selection is performed based on an identity associated with the user. Further, the contextual profile is associated with one or more contextual sub-profiles. Furthermore, each of the contextual sub-profiles is associated with each of the devices. The mapping module then maps at least one of the contextual profiles and the captured contextual attributes with a plurality of pre-stored advertisements. Thereafter, the suggestion module suggests the advertisement on the device based on the mapping.

The method and the system described above have numerous advantages. The present invention facilitates a recommendation of contextual advertisements to a user by taking into account the interest demonstrated by the user on multiple devices of content delivery. Therefore, the contextual advertisements are identified by leveraging cross-device knowledge of the user's interest. Further, the recommendation also takes into consideration the static information associated with the user in conjunction to his interest on the content displayed on multiple devices.

In addition to the advantages mentioned above, the present invention enables personalization of the contextual advertisements by considering one or more preferences indicated by the user. Further, even after the contextual advertisements are displayed to the user, the present invention allows displaying a new contextual advertisement based on the interaction of the user with the suggested contextual advertisements. The present invention also supports recommendation of cross-genre contextual advertisements.

The present invention also facilitates periodically capturing the change in the user's interest patterns while interacting with the multiple devices of content delivery. This helps to dynamically capture the change in the user's interest over a period of time.

### BRIEF DESCRIPTION OF THE DRAWINGS

The various embodiments of the invention will hereinafter be described in conjunction with the appended drawings, provided to illustrate, and not to limit, the invention, wherein like designations denote like elements, and in which:

FIG. 1 illustrates an exemplary environment in which various embodiments of the invention may be practiced;

FIG. 2 is a flowchart for creating a contextual profile for a user, in accordance with an embodiment of the invention;

FIG. 3 is a flowchart for creating a contextual sub-profile for the user, in accordance with the embodiment of the invention;

FIGS. 4A, 4B, and 4C illustrate a flowchart for recommending at least one contextual advertisement to a user, in accordance with an embodiment of the invention;

FIG. 5 is a block diagram of an exemplary contextual profile; and

FIG. 6 is a block diagram of a system for recommending at least one contextual advertisement to a user, in accordance with an embodiment of the invention.

### DETAILED DESCRIPTION OF THE DRAWINGS

The present invention provides a method, a system, and a computer program product for recommending contextual advertisements to a user. The method takes into account the interest exhibited by the user over at least two devices of content delivery. Further, the historical data of the user's interest exhibited over the devices is evaluated. Based on the evaluation, the contextual advertisements are recommended to the user.

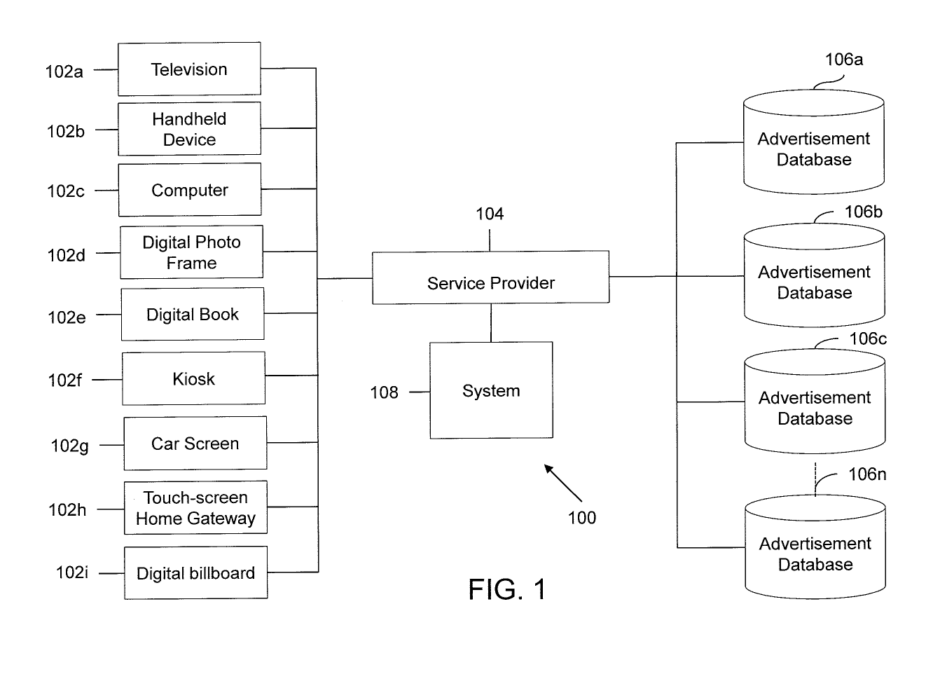

FIG. 1 illustrates an exemplary environment 100 in which various embodiments of the invention may be practiced. Environment 100 includes a plurality of devices 102a-102i, a service provider 104, one or more advertisement databases 106a-106n, and a system 108.

Service provider 104 interacts with devices 102a-102i, and advertisement databases 106a-106n. Further, system 108, in interaction with service provider 104, accesses the information available from devices 102, such as a device 102a. a device 102b, a device 102c, and so forth, and advertisement databases 106, such as an advertisement database 106a, an advertisement database 106b, an advertisement database 106c, and so forth. Service provider 104, devices 102a-102i (hereinafter referred to as devices), advertisement databases 106a-106n (hereinafter referred to as advertisement databases), and system 108 are connected via a communication link.

Devices connected to system 108 are employed for content delivery, i.e., to deliver media contents such as audio, video, text, software, and a combination thereof. The devices also support rendering of advertisements. Examples of devices include a television 102a, a handheld device 102b, a computer 102c, a digital photo frame 102d, a digital book 102e, a kiosk 102f, a car screen 102g, a touch-screen home gateway 102h, and a digital billboard 102i. It may be apparent to any person skilled in the art that system 108 may be scaled to connect with any tangible number of devices.

In a preferred embodiment of the present invention, a user (not shown in FIG. 1) is associated with at least two devices. Therefore, the user employs two or more of the above mentioned devices for receiving and sending media content. For example, the user may be associated with television 102a, handheld device 102b, and digital book 102e.

The user is registered with service provider 104 that provides multiple services on the devices. For example, the user may enroll for a quadruple play service, where he receives a bundle of Internet access, Voice over Internet Protocol (VoIP), and Tele Vision (TV) over IP. Further, service provider 104 assigns a unique identifier for identifying the user using a subscriber identity mechanism. Therefore, even if the user accesses the services from computer 102c, or from digital book 102e, service provider 104 will recognize that the same user is accessing the services using different devices. In an embodiment of the present invention, the unique identifier is the user's social security number. In another embodiment of the present invention, the unique identifier may be a phone number, an International Mobile Equipment Identity (IMEI), a login identifier, an Internet Protocol (IP) address, a Media Access Control (MAC) address, a registration IDentifier (ID), an image of the user, or a combination thereof.

In an alternate embodiment of the present invention, the user may be registered with multiple service providers, such as service provider 104, such that some services are provided by one service provider, while the other services are provided by other service providers. In such a scenario, the service providers will merge their respective unique identifiers for the user to yield one generic unique identifier. It may be apparent to any person skilled in the art that the service providers will have to collaborate with each other to successfully recognize the user who may use multiple devices at different times.

System 108 recommends at least one contextual advertisement by evaluating the behavior exhibited by the user on the devices, such as television 102a, handheld device 102b, and digital book 102e. To facilitate the recommendation, system 108 communicates with service provider 104 to access information about the user's behavior on the devices. Further, since service provider 104 is connected to advertisement databases 106, system 108 also gains access to the advertisements to be suggested/recommended to the user.

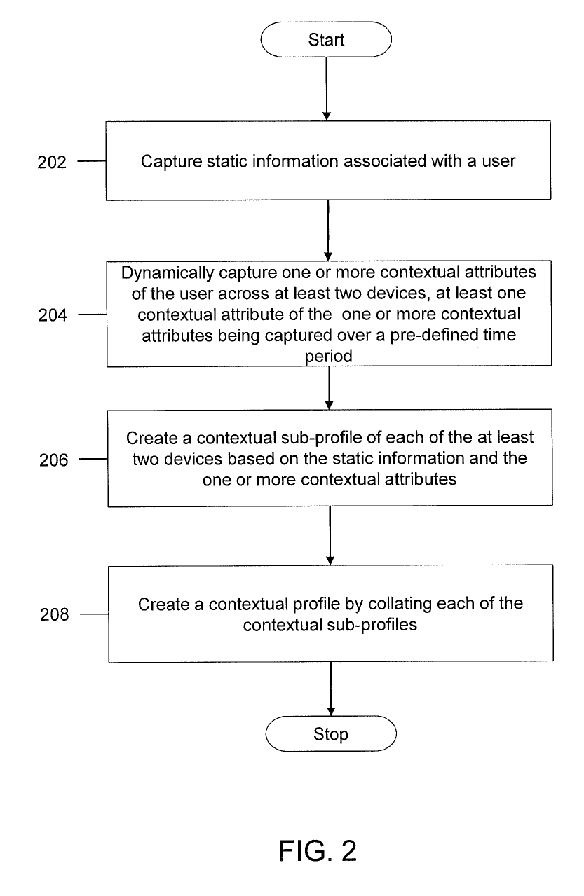

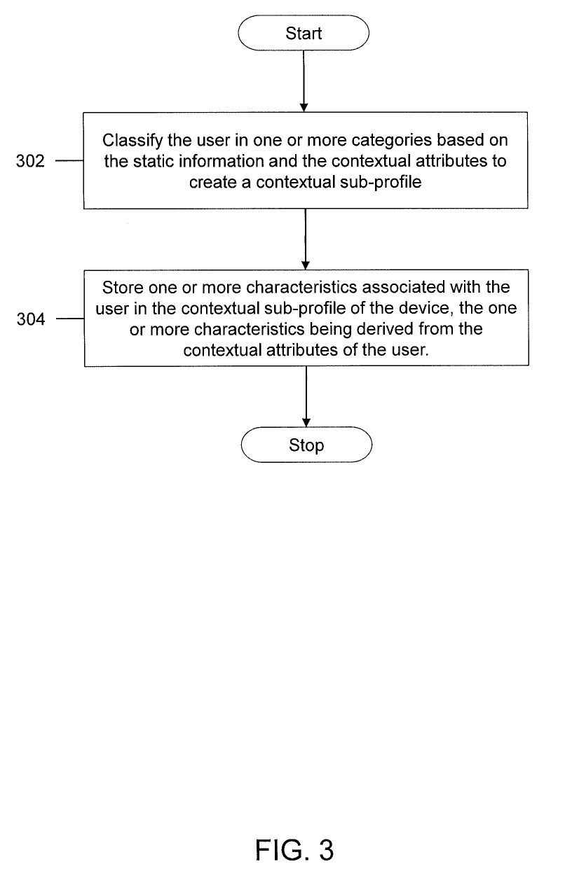

For making a recommendation, system 108 utilizes a contextual profile that stores the behavioral analysis of the user across multiple devices. The contextual profile is a compilation of multiple contextual sub-profiles, such that each contextual sub-profile is associated with each device. For example, if the user accesses television 102a, handheld device 102b, and computer 102c, a contextual sub-profile is created for each of the devices. Each contextual sub-profile includes the categories under which the user is classified based on the attributes associated with the user on the corresponding device. Further, the creation of the contextual profile and the contextual sub-profiles has been explained in detail in conjunction with FIG. 2 and FIG. 3.

FIG. 2 is a flowchart for creating a contextual profile for a user, in accordance with an embodiment of the invention.

For the sake of clarity and brevity, the at least two devices will hereinafter be exemplified as television 102a, handheld device 102b, and computer 102c. The creation of a contextual sub-profile for each of the above mentioned devices will now be explained in detail.

At 202, static information associated with the user is captured. In an embodiment of the present invention, the static information corresponds to data provided by the user while registering for a service, e.g., creating a new e-mail account, creating a new account with an e-commerce website, and the like. The registration page of a service usually includes mandatory fields and optional fields. Further, the user is prompted to fill-in data corresponding to all the mandatory fields. The information provided corresponding to all the mandatory fields and some/all the optional fields constitutes the static information.

The static information includes, but is not limited to, an age, an age group, a gender, educational qualifications, religion, languages, an ethnicity, an address of the user, professional details, a job profile, a marital status, and an income level. The user may also indicate one or more preferences during registration. For example, the user agrees to receive Really Simple Syndication (RSS) feeds, newsletters, or alerts for a certain technology or products. The preferences declared by the user are also added to the static information.

The static information of the user does not change frequently. For example, let us assume that the users from the age group 18-50 years are classified as “adults”, and a user has indicated his present age as 19 years. Therefore, the age group associated with the user will not change drastically with each passing year. Thus, the present invention re-captures the static information associated with the user only after a pre-determined time period. The pre-determined time period is selected such that the computational load is minimized, while taking into account an aging factor associated with the static information. In other words, the computational load associated with frequently capturing the static information is reduced. In an embodiment of the present invention, the pre-determined time period is defined in real-time. In another embodiment of the present invention, the pre-determined time period may be pre-programmed by an administrator.

At 204, one or more contextual attributes associated with the user are dynamically captured across the at least two devices. The contextual attributes are captured as soon as the user initiates an interactive session on any one of the devices.

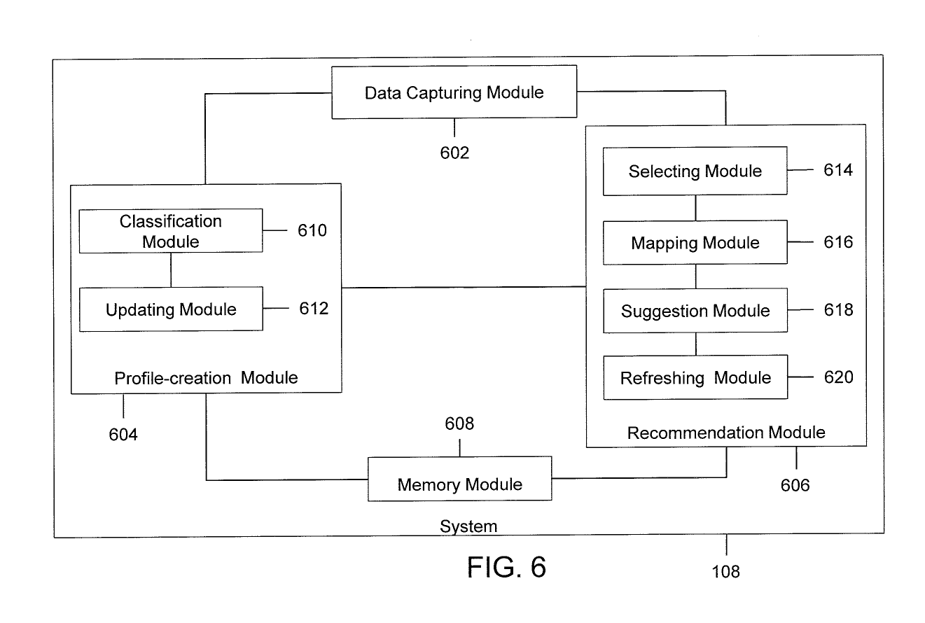

The interactive session corresponds to a session activated by the user on the devices. The interactive session may include a web session activated on a device or a local session between the user and the device. For example, the user initiates a live web session on handheld device 102b. In another example, the user downloads an application, such as a game, on handheld device 102b and later initiates a local session with the application. Yet another example of the interactive session may be a local session with television 102a. In an embodiment of the present invention, the interactive session may also include an implicit session with a device. For example, the act of looking at the contents of digital billboard 102i for more than a predetermined period of time constitutes the implicit session. In accordance with the embodiment of the present invention, the predefined time duration may range from one second to any tangible time metric. Further, recognizing/identifying of the user has been explained in detail in conjunction with FIG. 6.

The contextual attributes are broadly classified as temporal attributes, device-identification attributes, location attributes, and behavioral attributes. These will be explained below in conjunction with various examples:

Temporal Attributes

The temporal attributes include a time-based metric associated with each interactive session, such as a time of initiating the interactive session and the time duration of the interactive session. The time-based metric may be measured in terms of minutes, hours, days, weeks, months, and years. Further, the time-based metric may also be classified, such as before noon, post midnight, and over 1:00-4:00 PM. The time-based metric may also be measured in terms of a current season, such as summer, spring, autumn, and winter.

Device-Identification Attributes

The device-identification attributes identify the device which is used for initiating the interactive session. For example, when the interactive session is initiated on computer 102c, the device-identification attribute will correspond to “computer”.

Location Attributes

The location attributes include the location details associated with the user, such as a current location from where the interactive session is conducted. The current location of the user may be measured in absolute terms, such as “Redwood Shores, California”. The current location may also be measured relatively, such as “Redwood Shores, near McDonalds, California”.

Behavioral Attributes

The behavioral attributes include a content being watched, current activities of the user on the content being watched, a current state of the user, and one or more keywords associated with the interactive session. The behavioral attributes will be exemplified below.

a. The Content being Watched:

The content which is currently watched or surfed by the user constitutes the behavioral attributes. For the sake of clarity of the present invention, the content may include a web page, a website, a television channel, a blog, a file, a software application, a user interface, and the like.

b. The Current Activities of the User:

The current activities are classified as browsing the content, downloading the content, sharing the content, purchasing a product/service, and furnishing a feedback.

Examples of downloading the content include downloading a software application, a web page, or a file. Further, the file may be, but is not limited to, a whitepaper, a source code, a music file, a video file, a coupon, and a voucher.

For sharing the content, the user may utilize various means such as e-mail or instant messenger. The user may also use the options available on the user interface of the content being watched. The options typically include “Recommend to a friend”, “Send to a friend”, “Discuss”, and the like.

Examples of furnishing a feedback include providing a comment or a rating on the content/product/service, and filling in a survey for the content/product/service.

In an embodiment of the present invention, the current activities may also include clicking on a hyperlink or a displayed advertisement, without downloading or purchasing the content or product/service.

In another embodiment of the present invention, a score may be assigned to each of the current activities. The range of values assigned for the scores is determined by the administrator. For instance, clicking on a hyperlink may be assigned a lesser score than the one assigned to purchasing a product. The scores are utilized while recommending the advertisements to be displayed to the user. As an example, let us consider that the current activities of the user indicate that he/she frequently clicked on advertisements related to apparels, and he/she purchased a bouquet online. So, the score assigned to the activity vis-à-vis purchasing is higher than the score assigned for clicking on apparels' advertisements. Consequently, the scores might translate into displaying more advertisements related to online bouquet purchase and delivery, instead of the ones for apparels.

c. The One or More Keywords Associated with the Interactive Session:

The behavioral attributes also include one or more keywords associated with the interactive session. The keywords are determined based on the device on which the interactive session is initiated. For example, when the interactive session is conducted on television 102a, the keywords may be determined from the Electronic Programming Guide (EPG). However, if the interactive session is a web session on handheld device 102b, the keywords are determined from one or more search words input by the user. For example, the user may have frequently searched for word “Albert Einstein”. This will be captured as a contextual attribute associated with the user. The keywords may also be the most recurrent words on the content or in the source code of the web pages that the user browses. For example, the user may not have entered any search words, however, he/she was found to be frequently visiting the biography of Newton on the web. In a preferred embodiment of the present invention, the keywords are determined by scanning the web pages, or by analyzing web history or logs.

d. The Current State of the User:

The current state may include “busy”, “idle”, “hurry”, “meeting”, “out of office”, and the like. In an embodiment of the present invention, the current state of the user is determined from the status that the user displays on the web, such as on an instant messenger and e-mail applications. In another embodiment of the present invention, the current state may also include “mobile switched off”, “travelling abroad”, “out of home location”, “frequently changing channels on a television”, and the like.

In conjunction to the temporal attributes, the device-identification attributes, the location attributes, and the behavioral attributes, the contextual attributes may also include surrounding events associated with the user. The surrounding events include the current political scenario, such as elections; the current sports scenarios, such as a football world cup; a festival season, such as Thanksgiving and Christmas. In an embodiment of the present invention, the surrounding events are determined using a web crawler which periodically fetches information from the web. In an embodiment of the present invention, the web crawler performs a spider search on pre-determined news-related websites, online magazines, sports related websites, and the like for determining the latest activities. For example, the web crawler may fetch news related items every week from prominent websites. Further, the search may be also restricted based on the current location of the user. For example, if the current location of the user is the US, the festivals impending only in the country will be identified.

In an embodiment of the present invention, the surrounding events may be manually entered by the administrator on a regular basis. In another embodiment of the present invention, the surrounding events may also be manually entered by a campaign provider. The campaigns/advertisements associated with the surrounding events may then be delivered to the users. For example, let us consider that an air crash tragedy has occurred. The campaign provider may manually indicate this occurrence as a surrounding event. Subsequently, the campaigns/advertisements related to life-insurances or medical aids may be rendered to the users.

In another embodiment of the present invention, one or more derived contextual attributes may also be included in the contextual attributes. The derived contextual attributes are obtained from a combination of the contextual attributes. Let us assume that the contextual location attribute of the user indicates that he is “at present standing next to a sports shop”. The derived contextual attribute may then be computed from the contextual location attribute and the browsing activity of the user. As a result of the computation, the derived contextual attribute “standing next to a sports shop looking for a product” is obtained. Another example of the derived contextual attributes may be “recently became a parent”. This can be computed based on a status displayed by the user on a social-networking website, or the browsing activity of the user. The browsing activity of the user may indicate that there is the user's online purchasing activity has suddenly shifted to buying baby foods, or child-care products. Similarly, other examples of derived contextual attributes may be “does banking transactions only in the forenoon”, “travels abroad during Christmas”, “recently searched for real estate property”, and the like.

In yet another embodiment of the present invention, the content that the user looked at on digital billboard 102i also represents a contextual attribute, such that the content indicates the implicit preference of the user.

At least one contextual attribute of the various contextual attributes discussed above is captured over a pre-defined time period. In a preferred embodiment of the present invention, the value assigned to the pre-defined time period ranges from one to any tangible metric. For example, the contextual attributes may be captured from an interactive session only once. However, in a preferred embodiment of the present invention, the contextual attributes are captured at regular intervals of time, such as every week, every fortnight, or every month.

In another embodiment of the present invention, each contextual attribute has a corresponding pre-defined time period. For example, the location of the user is captured each time an interactive session is initiated, while the surrounding events are captured after every week. In accordance with the embodiment of the present invention, the contextual attributes may be associated with similar pre-defined time period. For example, the current season and the surrounding events may have similar pre-defined time period, such as one week.

In a preferred embodiment of the present invention, the pre-defined time period is determined by the administrator. In another embodiment of the present invention, the pre-defined time period is determined based on the likelihood of change in the user's behavior. The change in the user's behavior and preferences can be broadly divided into a one-time change and a seasonal change. An example of the one-time change includes a change in the user's interest subject to his profession. For example, if the user switches his profession from a software application developer to an animator, his interests will change in light of the profession. He/She may now be interested in software specifically related to graphics and animations. Similarly, an example of the seasonal change includes a change in preferences subject to the current festival, e.g., Halloween. Therefore, the pre-defined time period may be determined based on whether the change is one-time or seasonal.

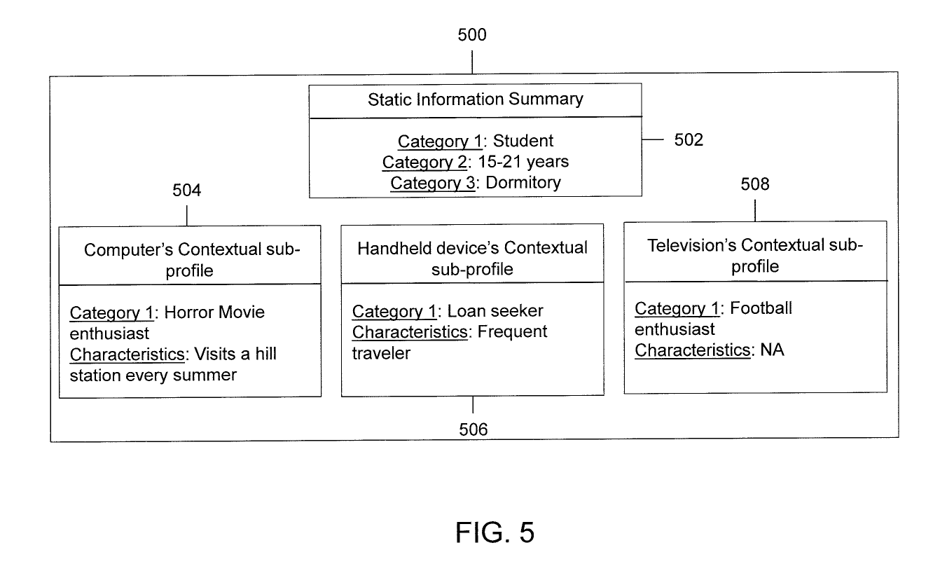

At 206, a contextual sub-profile is created for the devices. The contextual sub-profile is created using the static information and the captured contextual attributes. The method for creating the contextual sub-profile has been described in detail in conjunction with FIG. 3. At 208, the contextual sub-profiles of the user for each device are collated to create a contextual profile. In other words, the contextual profile contains consolidated information about the behavior exhibited by the user on each device, as well as the characteristics associated with the user. For example, referring to FIG. 5, a static information summary 502, a computer's contextual sub-profile 504, a handheld device's contextual sub-profile 506, and a television's contextual sub-profile 508 are collated to create a contextual profile 500 of the user.

FIG. 3 is a flowchart for creating a contextual sub-profile for the user. After obtaining the static information and the contextual attributes, the user is classified under one or more categories at 302. For the sake of clarity of the present invention, the classification will now be explained in conjunction with FIG. 3 and FIG. 5.

As an example, let us assume that the user is a student and belongs to an age group of 15-21 years with a preference to “Dormitory”. This information is derived based on the static information captured for the user. An initial categorization is performed where the user is assigned a category based only on the static information. In FIG. 5, the initial categorization is represented in static information summary 502, where the user is assigned initial categories of “Student”, “15-21 years”, and “Dormitory”. In a preferred embodiment of the present invention, only if a single unit of information, e.g., age, is available, the user can still be classified into a category.

Thereafter, the contextual attributes of each device are processed which yields the potential interests exhibited by the user. Based on the captured contextual attributes, one or more categories are assigned to the user. For example, the user watches horror movies on computer 102c, surfs for education loans on handheld device 102b, and watches football on television 102a. Given the static information and the contextual attributes for each device, a contextual sub-profile for each device is created. With reference to FIG. 5, contextual sub-profile 504 designed for computer 102c will classify the user under the category “Horror Movie enthusiast”. Similarly, contextual sub-profile 506 designed for handheld device 102b will classify the user under the category “Loan seeker”, while contextual sub-profile 508 for television 102a will classify the user as a “Football enthusiast”.

In an embodiment of the present invention, the method may be implemented for a plurality of users. Each user is first classified into a cluster based on the static information. For example, the clusters may be based on the age groups: “young”, “teenage”, and “adult”. Each user in the cluster is then classified based on the remaining static information and the contextual attributes.

Returning to FIG. 3, at 304, one or more characteristics associated with the user are stored in the corresponding contextual sub-profile. The one or more characteristics are analogous to the behavior exhibited by the user that cannot be categorized. In a preferred embodiment of the present invention, the one or more characteristics correspond to the derived contextual attributes. With reference to FIG. 5, contextual sub-profile 504 and contextual sub-profile 506 indicate characteristics “Visits a hill station every summer” and “Frequent traveler”, respectively. The characteristics are derived by processing the contextual attributes of the user, such as the current activities and the current season. For instance, the contextual attributes of the user over a period of time on computer 102c divulge that when the current season is summer, the user books hotel tickets for a hill station. Based on the given information, the characteristics of the user will be identified and stored in the corresponding contextual sub-profile. It may be apparent to a person skilled in the art that multiple categories and multiple characteristics may be associated with each contextual sub-profile.

The contextual profile of the user is then created by collating each contextual sub profile, as described in at 208 of FIG. 2. The created contextual profile is then stored in a database (not shown in FIG. 5). Further, the contextual profile is updated when a new set of contextual attributes are captured after the pre-defined time period.

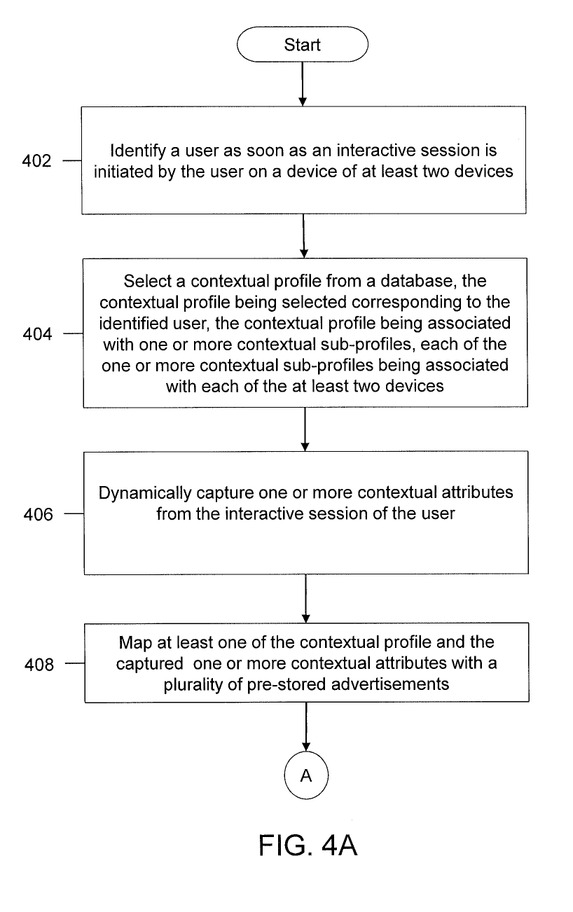

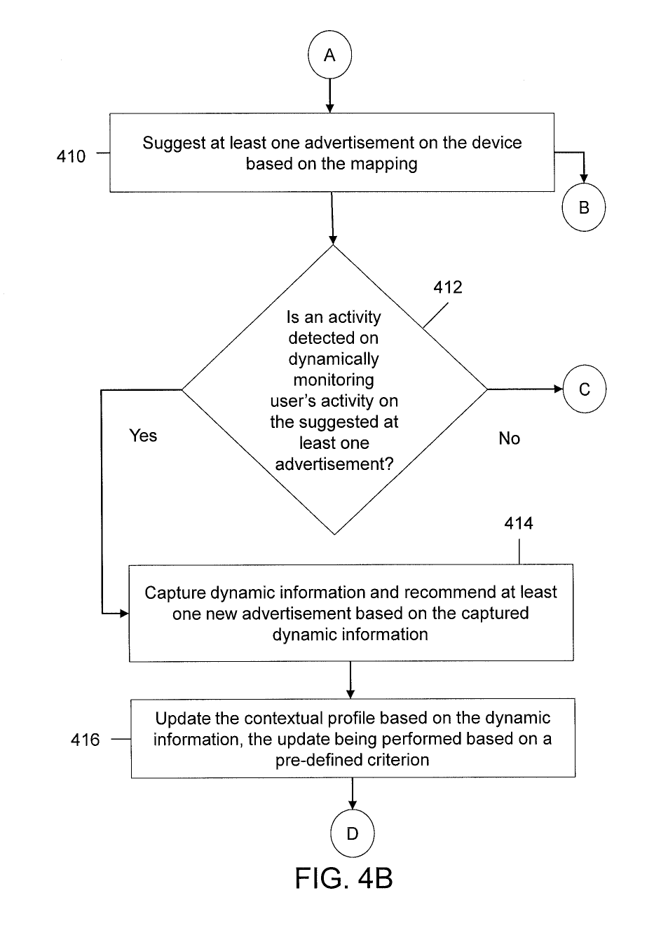

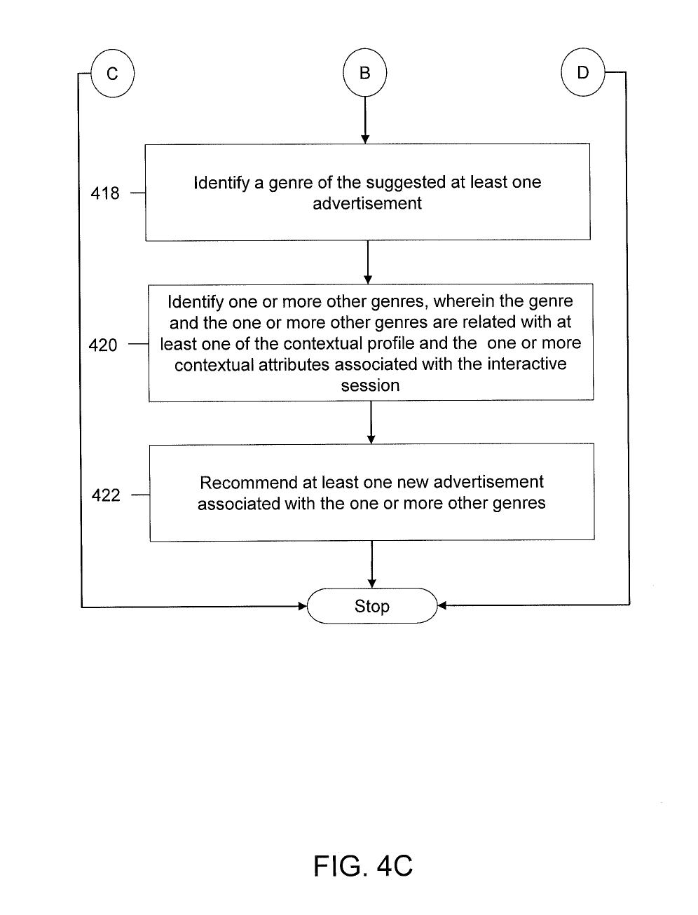

FIGS. 4A, 4B, and 4C illustrate a flowchart for recommending at least one contextual advertisement to a user, in accordance with an embodiment of the invention. The present invention will now be described in conjunction with FIGS. 4A, 4B, 4C, and FIG. 5.

At 402, a user is identified when the user initiates an interactive session on a device. Further, the user is identified by evaluating his/her unique identifier. In an embodiment of the present invention, the unique identifier is the user's social security number. In another embodiment of the present invention, the unique identifier may be a phone number, an International Mobile Equipment Identity (IMEI), a login address, an Internet Protocol (IP) address, a Media Access Control (MAC) address, a registration IDentifier (ID), an image of the user, or a combination thereof.

At 404, once the user is identified, his/her contextual profile is fetched from the database. As described above, the contextual profile contains one or more contextual sub-profiles that are associated with the corresponding devices of the user.

In continuation with the above example where the user is associated with television 102a, handheld device 102b, and computer 102c, let us now consider that the user initiates the interactive session on handheld device 102b. As soon as the interactive session is initiated, the unique identity of the user is determined. With reference to FIG. 5, based on the unique identity, contextual profile 500 is fetched. As discussed, contextual profile 500 contains contextual sub-profile 506 corresponding to handheld device 102b, and contextual sub-profile 504 and contextual sub-profile 508 for television 102a and computer 102c, respectively.

At 406, the contextual attributes associated with the interactive session are dynamically captured in real-time. As described above, the contextual attributes include, but are not limited to, the time of initiating the interactive session, the time duration of the interactive session, the current location of the user, the device of the at least two devices for initiating the interactive session, the current season, the current state of the user, the surrounding events, the content being watched, the current activities of the user, and the one or more keywords associated with the interactive session.

In a preferred embodiment of the present invention, the contextual attributes are captured only after a pre-defined time duration of the interactive session. As an example, let us assume that when the user initiates the interactive session on handheld device 102b, he/she begins surfing for movies for a short duration of time, say two minutes. However, at the end of the short duration of time, he/she starts conducting bank-related transactions for the next one hour. Therefore, since the surfing of movies was a transient activity, it does not describe the behavior of the user. The pre-defined time duration associated with capturing of the contextual attributes ensures that the contextual attributes will only be obtained when the interactive session is conducted for a considerable amount of time. Further, the pre-defined time duration is determined by the administrator. In another embodiment of the present invention, the pre-defined time duration may also be programmed.

In an embodiment of the present invention, fetching of the contextual profile from the database and capturing of the contextual attributes are carried out in parallel. It may be apparent to a person skilled in the art that fetching and capturing may also be carried out sequentially.

At 408, at least one of the contextual profile and the contextual attributes are mapped with a plurality of pre-stored advertisements.

In an embodiment of the present invention, no contextual attributes may be associated with the interactive session. For example, let us assume that the user has initiated a session on a web browser on handheld device 102b, and he/she has neither selected any fields nor entered any data. In such a scenario, no contextual attributes are captured. The mapping in this case is solely conducted between the contextual profile of the user and the pre-stored advertisements. For conducting the mapping, the categories under which the user is classified in all the contextual sub-profiles are considered. Therefore, even though the user is currently navigating on handheld device 102b, his preferences exhibited on television 102a and computer 102c will also be taken into account. Subsequently, the categories under which the user is classified for handheld device 102b, television 102a and computer 102c will be mapped with the categories assigned to the pre-stored advertisements. With reference to FIG. 5, the user has been categorized under “Horror Movie enthusiast” for computer 102c, “Loan seeker” for handheld device 102b, and “Football enthusiast” for television 102a. Therefore, the above categories will be mapped to the categories “Horror Movies”, “Loans”, and “Football” of pre-stored advertisements. Further, the mapping may also be performed between the characteristics stored in each contextual sub-profile and the pre-stored advertisements. For example, the characteristic stored in contextual sub-profile 506 of handheld device 102b denotes “Frequent traveler”. The characteristic will be now mapped with the “Travel” category of the pre-stored advertisements.

In a preferred embodiment of the present invention, the pre-stored advertisements are pre-catalogued in an advertising taxonomy under various categories. The cataloguing is performed by analyzing the keywords associated with each of the pre-stored advertisements. The mapping described above takes into account the conceptual similarity between the categories assigned to the user in the contextual sub-profiles and the categories of pre-stored advertisements. For example, let us consider that the user is assigned a category “Movie enthusiast”, while the category assigned to the pre-stored advertisements is “Films”. Using conceptual-semantic and lexical relations, a similarity between “Movies” and “Films” is determined. It may be apparent to a person skilled in the art that any of the existing technologies may be utilized for perform the mapping.

However, if the contextual attributes of the interactive session are available, the mapping will take into consideration both the contextual profile and the contextual attributes. In the example discussed above, even though the contextual profile of the user indicates that the user is a “Horror Movie enthusiast” for computer 102c, a “Loan seeker” for handheld device 102b, and a “Football enthusiast” for television 102a, the user is browsing through gaming software on handheld device 102b for a considerable amount of time. The new preference displayed by the user, i.e., browsing gaming software, will compose the contextual attributes. Thus, the contextual attributes and the contextual profile will be mapped to the four categories of advertisements—“Gaming software”, “Horror Movies”, “Loans”, and “Football. Similarly, let us assume that the user initiates a new implicit interactive session with digital billboard 102i which displays content related to an upcoming dance festival. The contextual attributes now corresponds to a new preference “dance”. Now using the contextual attributes as well as the contextual profile, advertisements related to “Horror Movies”, “Loans”, and “Football will be mapped and subsequently displayed to the user on digital billboard 102i. It may be apparent to any person skilled in the art that new preferences exhibited by the user may be then stored in the contextual sub-profile of the corresponding device.

In an embodiment of the present invention, the administrator may assign weights to the contextual profile and the contextual attributes. Therefore, based on these weights, the administrator may assign a higher priority to particular preferences, such as preferences declared by the user in the static information. Similarly, the administrator may assign a higher priority to the contextual attributes displayed during the current interactive session on handheld device 102b based on the assigned weights.

Returning to FIG. 4, at 410, at least one advertisement is suggested to the user based on the mapping established between at least one of the contextual profile and the contextual attributes and the categories of the pre-stored advertisements. With reference to FIG. 5, an advertisement related to a new horror movie, a new home loan, an upcoming football world cup, or a combination thereof is recommended. Therefore, even though the user is currently browsing on handheld device 102b, knowledge about his/her behavior on other devices is leveraged while conducting the mapping. In addition, since the contextual profile includes exhibited characteristics and indicated preferences of the user, the suggestion of the advertisement is personalized for the user. It may be apparent to a person skilled in the art that subject to the established mapping, the advertisements ranging from one to a tangible number will be displayed to the user.

In an embodiment of the present invention, a feature drift associated with the user is also taken into consideration while recommending an advertisement. The feature drift captures the variation in the behavior exhibited by the user with time. To ensure that the changes in the user's behavior are captured, the contextual profile is updated at a regular interval of time. For example, the user may exhibit a new set of characteristics in his recent interactive sessions. The new set of characteristics will be added to the corresponding contextual sub-profile of the device. Therefore, the entire contextual profile of the user will be updated. This ensures that the dynamism associated with the user's behavior is regularly captured.

After the suggested advertisement is displayed to the user, 412 and 418 will be performed in parallel. At 412, it is dynamically checked if an activity of the user is detected on the suggested advertisement. The current activities include, but are not limited to, downloading a content promoted by the suggested advertisement, sharing the content promoted by the suggested advertisement, purchasing a product/service promoted by the suggested advertisement, and providing a feedback on the suggested advertisement. The content may be a software application, a product, and a file. Further, the user may furnish the feedback by providing a comment or a rating on the content, the product/service, or on the suggested advertisement. The user may also fill in a survey for the content, the product/service, or for the suggested advertisement. The current activities may also include clicking on the suggested at least one advertisement, without downloading or purchasing the content or product/service.

If the current activities are detected, 414 is performed. At 414, dynamic information vis-à-vis the current activities is captured. The dynamic information includes at least one of a pattern of clicks exhibited by the user, the information on a survey associated with the suggested advertisement, or the information on the rating associated with the suggested advertisements, or a combination thereof. Each piece of the above dynamic information will now be discussed in detail.

The Pattern of Clicks Exhibited by the User

As an example, let us assume that the user clicks on the suggested advertisement and downloads a product promoted by the suggested advertisement. An associative rule mining technique is then deployed to ascertain the relation between the interest declared by the user on the suggested advertisement and the pre-stored advertisements. Let us assume that the suggested advertisement is corresponding to a cell phone. The user clicks on the suggested advertisement and buys the cell phone. Using associative rule mining, it may be ascertained that {Cell phone} [symbol] {Service provider plans}. Consequently, at least one new advertisement corresponding to a service provider plan will be displayed to the user.

In a preferred embodiment of the present invention, the associative rule mining is implemented across the plurality of devices. With reference to FIG. 5, contextual profile 500 declares the user as a “Traveler”. Let us assume that an advertisement corresponding to a holiday package is suggested to the user on handheld device 102b. Thereafter, the user repeatedly clicks on the suggested advertisement on handheld device 102b. In this scenario, the dynamic information will correspond to the pattern of clicks exhibited by the user on the suggested advertisement, i.e., the holiday package. Now let us assume that the user starts another interactive session on computer 102c. Using associative rule mining, it is ascertained that {Holiday Packages} [symbol] {Travel luggage}. Therefore, at least one new advertisement corresponding to travel luggage will be displayed to the user on computer 102c, even though the suggested advertisement on the holiday package was displayed on handheld device 102b.

In another embodiment of the present invention, associative rule mining technique also predicts the user's interest during a current interactive session. For performing the prediction, the past behavior of all users is evaluated to capture the set of “items” that are chosen together most frequently. As an example, let us consider that the user is browsing a bank website on computer 102c. By analyzing a predetermined number of clicks exhibited by the user, the specific service that he/she is searching for can be predicted. For example, the associate rule mining may predict that based on the past behavior of other users, the probability of visiting fixed-term deposit accounts is high after the other users exhibit at least three clicks on a savings account statement. Subsequently, at least one new advertisement for opening a fixed-terms deposit account may be displayed. It may be apparent to a person skilled in the art that any of the existing technologies may be utilized for performing the associative rule mining.

The Survey Information and the Rating Information

The dynamic information also includes the survey information and the rating information associated with the suggested advertisement. In an embodiment of the present invention, a collaborative filtering routine is employed to evaluate the survey information and the rating information. According to the collaborative filtering routine, the survey information and the rating information disclosed by other users on the suggested advertisement is determined. As an example, let us assume that the suggested advertisement displayed to the user corresponds to an upcoming horror movie. The user then provides a rating of 4 out of 5 to the upcoming horror movie. The collaborative filtering routine then fetches the rating information entered by other users on the upcoming horror movie, and determines a correlation between the user and the other users based on the ratings. Therefore, the other users who have also provided a rating of 4 out of 5 to the upcoming horror movie are identified. The survey information or the rating information provided by these users for one or more other content will be evaluated. For example, the other users may have entered rating information for merchandise of the upcoming horror movie. Subsequently, at least one new advertisement corresponding to the merchandise of the upcoming horror movie will be displayed to the user.

The examples of dynamic information described above are captured online. In another embodiment of the present invention, the dynamic information may also be captured offline. For example, after every month the users are distributed fill-in survey forms, or questionnaires for programs and advertisements displayed on television 102a for the entire month. The information provided in the forms/questionnaires by the users is then fed into system 108 by the administrator.

At 416, the dynamic information is processed and a set of contextual attributes are identified. For example, let us assume that the dynamic information corresponds to a click exhibited by the user on the suggested advertisement, such that the clicks resulted in downloading of a product promoted by the suggested advertisement. The set of contextual attributes may include one or more keywords associated with the downloaded product. The set of contextual attributes obtained from the dynamic information will be added to the contextual profile of the user based on a pre-defined criterion. First, a comparison is performed between the set of contextual attributes and the contextual attributes of the contextual sub-profile. For example, if the set of attributes are derived for television 102a, the comparison will be with the contextual attributes stored in the contextual sub-profile of television 102a. The contextual sub-profile is updated only when there is a difference between the set of contextual attributes and the contextual attributes stored in the contextual sub-profile.

At 418, a genre of the suggested advertisement is determined. In an embodiment of the present invention, each of the pre-stored advertisements is associated with a genre. Further, each of the pre-stored advertisements under a genre has a set of associated keywords. For example, each advertisement under category “Sports” is further associated with a genre, say “Cricket”, “Football”, and the like. Further, each advertisement under, say “Football” has a set of associated keywords, such as names of prominent footballers or popular football tournaments.

The determination of the genre of the suggested advertisement will now be explained using the following example.

Let us assume that the suggested advertisement belongs to the genre “Football”. Then at 420, one or more other genres that are related to the genre of the suggested advertisement are identified. For example, if the keywords of the contextual profile indicated “David Beckham”, and the contextual attributes of the interactive session also depicted that the user was surfing for a football gear, the suggested advertisement of genre “Football” was displayed to the user. Now using at least one of the keywords of the contextual profile and the contextual attributes of the interactive session, one or more other genres of advertisements are determined. With reference to the above example, since the keyword was “David Beckham”, a comparison is performed with the pre-stored advertisements that contain “David Beckham” in their set of associated keywords. As a result of the comparison, at least one new advertisement of a class “Apparels” and a genre “Adidas” may be determined, since the genre “Adidas” may have “David Beckham” in its set of associated keywords.

In the above example, the contextual profile of the user indicated the category “Football enthusiast” and a characteristic “Frequent traveler”, following which the suggested advertisement of the genre “Football” was displayed to the user. Thereafter, based on the contextual profile of the user, at least one new advertisement for “Travel to world cup football in South Africa” may also be identified.

After the comparison, at 422, at least one new advertisement of the class “Apparels” and the genre “Adidas” is displayed to the user. In another embodiment of the present invention, the suggestions of the at least one new advertisement either of another genre (418-422) or suggesting based on the current activities (412-416) is optional.

In another embodiment of the present invention, a genre of each of the pre-stored advertisements can further be sub-divided into one or more sub-genres. For example, if the class is “Music”, a genre can be “Classical Music”, which can be further sub-divided into sub-genres such as “Opera” and “Instrumental”. In yet another embodiment of the present invention, the pre-stored advertisement may also be associated with labels such as a “mode of delivery”. For example, certain advertisements may not be suitable on handheld device 102b because of resolution requirement. The label associated with such advertisements will describe the devices on which these should be rendered.

FIG. 6 is a block diagram of system 108 for recommending at least one contextual advertisement to a user, in accordance with an embodiment of the invention. System 108 includes a data capturing module 602, a profile-creation module 604, a recommendation module 606, and a memory module 608. Profile-creation module 604 further includes a classification module 610 and an updating module 612. Recommendation module 606 further includes a selecting module 614, a mapping module 616, a suggestion module 618, and a refreshing module 620.

In a preferred embodiment of the present invention, when a user initiates an interactive session on a device, service provider 104 (not shown in FIG. 6) identifies the user using a unique identifier. In addition, system 108 is activated as soon as the interactive session is initiated. Service provider 104 then relays the unique identifier to system 108. In a preferred embodiment of the present invention, system 108 stores each contextual profile with a corresponding unique identifier in memory module 608. After receiving the unique identifier from service provider 104, system 108 selects the contextual profile stored in memory module 608 based on the received unique identifier.

As soon as system 108 is activated, data capturing module 602 starts capturing one or more contextual attributes from the interactive session, as explained in conjunction with FIG. 2. Data capturing module 602 utilizes techniques such as access logs, parsing algorithms, and web crawlers to capture the contextual attributes. The techniques will now be discussed in detail.

Access Logs:

In a preferred embodiment of the present invention, data capturing module 602 obtains access logs for the interactive session. The access logs are then processed to generate the contextual attributes. The access logs include logs pertaining to a web session that indicate a time of initiating the interactive session, a time duration of interactive session, URLs visited, a location of the user, total number of web pages viewed, most viewed web pages or websites, downloaded contents, and the like. It is apparent to a person skilled in the art that the logs for the web session can be analyzed using any of the existing web log analyzers. The access logs also include logs pertaining to local sessions, such as EPG logs, billing information from service provider 104, batch information from a set-top box, and the like. The logs pertaining to local sessions are captured from service provider 104 at regular intervals of time. For example, data capturing module 602 may capture the logs for a local session on a monthly basis.

Parsing Algorithms:

When one or more keywords need to be identified from the interactive session, data capturing module 602 employs a parsing algorithm. The parsing algorithm scans through web pages or channels visited during the interactive session. The most recurrent words of the content and one or more search words entered by the user are then extracted. The recurrent words and the search words then constitute the keywords. Further, the parsing algorithm may also determine the keywords by scanning through the source code of web pages. Similarly, the EPG logs are scanned to identify the keywords from the channels watched on television 102a. It may be apparent to a person skilled in the art that any of the existing technologies may be utilized for performing the parsing.

Web Crawlers:

As discussed in the detailed explanation of FIG. 2, surrounding events, current activities, and current status of the user also constitute the contextual attributes. To capture the surrounding events, data capturing module 602 employs web crawlers that perform spider searches on pre-determined news related websites. The web crawlers can also be programmed to search other websites, such as sports-related websites and online magazines.

In an embodiment of the present invention, the web crawlers analyze the Document Object Model of the web pages to determine the current activities of the user. In another embodiment of the present invention, the web crawlers also scan through the current status displayed by the user on instant messengers or e-mail applications.

In addition to the capturing contextual attributes by access logs, parsing algorithms and web crawlers, data capturing module 602 also captures the content of digital billboard 102i as a contextual attribute corresponding to the user looking at digital billboard 102i. Further, prior to capturing the contextual attribute corresponding to digital billboard 102i, the user is first identified using facial recognition techniques. In a preferred embodiment of the present invention, one or more cameras are installed on digital billboard 102i. Thus, when the user starts to look at the displayed content, the image of the user is captured and is compared with other pre-stored images using facial recognition techniques. After the user is identified, the content which the user looked at is captured and stored in a corresponding contextual sub-profile of digital billboard 102i. The contextual sub-profile is then utilized to suggest advertisements to the user on other devices, including digital billboard 102i, of content delivery. In various embodiment of the present invention, the identification of the user using facial recognition techniques may be performed by service provider 104, data capturing module 602, or a third-party vendor. Further, it may be apparent to a person skilled in the art that any of the existing technologies may be utilized for conducting the facial recognition.

In a preferred embodiment of the present invention, the technique of recommending advertisements is executed in stages based on the availability of data. For example, if data capturing module 602 has captured survey/rating information for a user, the stage that recommends advertisements based on survey/rating information will be invoked. Similarly, it may be assumed that service provider 104 declines to provide access logs for the user. In such a scenario, the corresponding stage associated with access logs will not be invoked. In addition, if no data is available for the user, the stage that recommends random advertisements is invoked.

In an embodiment of the present invention, data capturing module 602 is associated with a timer (not shown in FIG. 6). One or more pre-defined time period is set in the timer by the administrator, such that at least one contextual attribute is associated with a corresponding pre-defined time period. In another embodiment of the present invention, the pre-defined time period may also be programmed.

Data capturing module 602 also obtains static information of the user from service provider 104. In addition, a pre-determined time period for capturing the static information is also set in the timer by the administrator.

Profile-creation module 604 creates a contextual sub-profile for each device. For creating each of the contextual sub-profiles, classification module 610 classifies the user into one or more categories based on the static information and the contextual attributes. Classification module 610 also stores one or more characteristics associated with the user in the corresponding contextual sub-profile. It may be apparent to a person skilled in the art that classification module 610 may be based on Support Vector Machine (SVM), Bayesian networks, Expectation Maximizing (EM) clustering algorithms, and the like. Further, the details for performing the classification have already been described in the detailed explanation of FIG. 2 and FIG. 3.

Thereafter, profile-creation module 604 collates each of the contextual sub-profiles to create a contextual profile of the user. Subsequently, the contextual profile is sent to memory module 608 for storage in a database (not shown in FIG. 6).

Since the capturing of the contextual attributes and the static information is associated with the timer, updating module 612 updates the corresponding contextual sub-profile for the device after each occurrence of capturing.

Memory module 608 stores the contextual profile in the database. In a preferred embodiment of the present invention, the contextual profile is stored along with the unique identifier. The unique identifier acts as an index for the contextual profile, based on which the contextual profile of the user can be differentiated from other contextual profiles. In an embodiment of the present invention, the database resides on system 108. In another embodiment of the present invention, the database may reside on service provider 104. In yet another embodiment of the present invention, the database may reside on a remote system connected to system 108. Further, as described above, after each occurrence of capturing of static information and the contextual attributes, the database is continuously updated.

The functionality of recommendation module 606 will now be described.

As discussed above, as soon as the user initiates the interactive session, the user is identified by service provider 104 using the unique identifier. Selecting module 614 then selects the contextual profile of the user from memory module 608 using the unique identifier. In a preferred embodiment of the present invention, the selection of the contextual profile and capturing the contextual attributes for the interactive session is conducted in parallel.

The contextual profile in conjunction with the contextual attributes is then relayed to mapping module 616. Subsequently, mapping module 616 conducts mapping between at least one of the contextual profile and the contextual attributes, and the categories of the pre-stored advertisement. Pursuant to the mapping, suggestion module 618 recommends at least one advertisement to the user. Further, the details for performing the mapping and the subsequent suggestion of the advertisement have already been described in the detailed explanation of FIG. 4.

In an embodiment of the present invention, even after the suggested advertisement is displayed to the user, data capturing module 602 concurrently monitors the current activities of the user on the suggested advertisement. When an activity is detected, data capturing module 602 obtains dynamic information corresponding to the current activities. The examples of dynamic information have been described in the detailed explanation of FIG. 4.

In a preferred embodiment of the present invention, when the dynamic information is obtained, suggestion module 618 suggests at least one new advertisement using techniques such as associative rule mining and collaborative filtering routines.

Further, the dynamic information vis-à-vis the suggested advertisement is processed by suggestion module 618 and a set of contextual attributes are acquired. Suggestion module 618 evaluates the set of contextual attributes based on a pre-defined criterion. The set of contextual attributes is compared with the contextual attributes of the contextual sub-profile. If a difference is identified, refreshing module 620 is triggered to refresh the contextual profile based on the set of contextual attributes derived from the dynamic information. Further, the details for refreshing the contextual profile based on the dynamic information have already been described in the explanation of FIG. 4.

In another embodiment of the present invention, suggestion module 618 also determines a genre of the suggested advertisement. One or more other genres that are related to the genre of the suggested advertisement are then identified. Subsequently, suggestion module 618 suggests a new advertisement belonging to the other genres. Further, the details for suggesting the new advertisement belonging to the other genres have already been described in the explanation of FIG. 4.

The method and the system described above have numerous advantages. The present invention facilitates recommendation of contextual advertisements to a user by taking in to account the interest demonstrated by the user on multiple devices of content delivery. Therefore, the contextual advertisements are identified by leveraging cross-device knowledge of the user's interest. Further, the recommendation also takes into consideration the static information associated with the user in conjunction to his interest on the content displayed on multiple devices.

In addition, the present invention enables personalization of the recommendation of contextual advertisements by considering one or more preferences indicated by the user. Further, even after the contextual advertisements are displayed to the user, the present invention allows displaying a new contextual advertisement based on the interaction of the user with the suggested contextual advertisements. The present invention also supports recommendation of cross-genre contextual advertisements.

The present invention facilitates periodically capturing the change in the user's interest patterns while interacting with the multiple devices of content delivery. This helps to capture the dynamic change in the user's interest over a period of time.

The present invention is applicable to a network that can be Internet, Local Area Network (LAN), Wide Area Network (WAN), a Wireless LAN, Metropolitan Area Network (MAN), a Global System for Mobile (GSM) communication network, a Code Division Multiple Access (CDMA) network, Enhanced Data rates for GSM Evolution (EDGE), Wireless Fidelity (Wi-Fi), Worldwide Interoperability for Microwave Access (WiMAX), and the like. Further, as described above the devices include television 102a, handheld device 102b, computer 102c, digital photo frame 102d, digital book 102e, kiosk 102f, car screen 102g, and touch-screen home gateway 102h. Various examples of television 102a include an Internet Protocol Television (IPTV), a cable TV, or a direct-to-home TV.

Various examples of computer 102c include a personal computer; a desktop device; and a device such as AT&T HomeManager®. Examples of digital book 102e includes Sony Reader®, Amazon Kindle®, Apple IPad®, Barnes & Noble Nook®, and Kobo eReader®. Further, examples of handheld device 102b include a mobile phone, a laptop, a personal digital assistant (PDA), a smart phone, or a mobile computing device. Various examples of the communication link through which service provider 104 interacts with the devices, advertisement databases 106, and system 108 may be wired, wireless, or a combination of both.

The method and system for recommending at least one advertisement to a user, such that the recommendation is provided based on the interaction with at least two devices, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for recommending at least one advertisement to a user, such that the recommendation is provided based on the interaction with at least two devices. The computer program product includes a computer readable storage medium having a set program instructions comprising a computer readable program code for recommending at least one advertisement to a user, such that the recommendation is provided based on the interaction with at least two devices. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

1. A method for recommending at least one advertisement to a user, the recommendation being provided based on the interaction with at least two devices, the method comprising:
a. identifying the user, the identification being performed when an interactive session is initiated by the user on a device of the at least two devices;
b. selecting a contextual profile from a database, the contextual profile being selected corresponding to the identified user, the contextual profile being associated with one or more contextual sub-profiles, each of the one or more contextual sub-profiles being associated with each of the at least two devices;
c. dynamically capturing one or more contextual attributes from the interactive session;
d. mapping at least one of the contextual profile and the captured one or more contextual attributes with a plurality of pre-stored advertisements; and
e. suggesting the at least one advertisement on the device based on the mapping.

2. The method of claim 1, wherein the at least two devices are selected from a group comprising a handheld device, a computer, a television, a car screen, a kiosk, a digital photo frame, a touch-screen home gateway, a digital billboard, and a digital book.

3. The method of claim 1, wherein the one or more contextual attributes comprise at least one of a time of initiating the interactive session, a time duration of the interactive session, a current location of the user, the device of the at least two devices for initiating the interactive session, a current season, a current state of the user, surrounding events, a content being watched, current activities of the user, and one or more keywords associated with the interactive session.

4. The method of claim 1, wherein the one or more contextual attributes are dynamically captured after a pre-defined time duration of the interactive session.

5. The method of claim 1 further comprising updating the contextual profile at regular intervals of time based on the one or more contextual attributes associated with the interactive session.

6. The method of claim 1 further comprising suggesting at least one new advertisement based on the suggested at least one advertisement.

7. The method of claim 6, wherein suggesting the at least one new advertisement comprises:
a. dynamically monitoring current activities of the user, the current activities being associated with the suggested at least one advertisement;
b. capturing dynamic information associated with the current activities of the user; and
c. recommending the at least one new advertisement from the plurality of pre-stored advertisements based on the captured dynamic information.

8. The method of claim 7, wherein the dynamic information comprises at least one of a survey information associated with the suggested at least one advertisement, a rating information associated with the suggested at least one advertisement, and a pattern of clicks exhibited by the user on the suggested at least one advertisement.

9. The method of claim 7, wherein the contextual profile is updated based on the dynamic information, the updation being performed based on a pre-defined criterion.

10. The method of claim 6, wherein suggesting the at least one new advertisement comprises:
a. identifying a genre associated with the suggested at least one advertisement;
b. identifying one or more other genres, wherein the genre and the one or more other genres are related with at least one of the contextual profile and the one or more contextual attributes associated with the interactive session; and
c. recommending the at least one new advertisement associated with the one or more other genres.

11. The method of claim 1 further comprising preparing the contextual profile for the user, the preparation comprising:
a. capturing static information and contextual attributes associated with the user, at least one contextual attribute of the contextual attributes being captured over a pre-defined time period, wherein the contextual attributes are captured across the at least two devices;
b. creating the contextual sub-profile for each of the at least two devices based on the static information and the contextual attributes; and
c. creating the contextual profile of the user by collating each of the contextual sub-profile.

12. The method of claim 11, wherein creating the contextual sub-profile of the user for the device further comprises classifying the user in one or more categories, the user being classified based on the static information and the contextual attributes.

13. The method of claim 12 further comprising storing one or more characteristics associated with the user in the contextual sub-profile for the device, the one or more characteristics being derived from the contextual attributes of the user.

14. The method of claim 11, wherein each of the at least one contextual attribute has a corresponding pre-defined time period.

15. The method of claim 11, wherein the static information comprises at least one of an age, an age group, a gender, one or more preferences, educational qualifications, religion, languages, an ethnicity, an address of the user, professional details, a job profile, a marital status, and an income level.

16. The method of claim 11 further comprising updating the contextual profile after the pre-defined time period.

17. The method of claim 11 further comprising storing the contextual profile in the database.

18. A method for preparing a contextual profile, the contextual profile being utilized for recommending at least one advertisement to a user, the recommendation being provided based on the interaction with at least two devices, the method comprising:
a. capturing static information associated with the user;
b. dynamically capturing one or more contextual attributes, at least one contextual attribute of the one or more contextual attributes being captured over a pre-defined time period, the one or more contextual attributes being captured across the at least two devices;
c. creating a contextual sub-profile for each of the at least two devices based on the static information and the one or more contextual attributes; and
d. creating the contextual profile of the user by collating each of the contextual sub-profile.

19. The method of claim 18, wherein creating the contextual sub-profile of the user for the device further comprises classifying the user in one or more categories, the user being classified based on the static information and the one or more contextual attributes.

20. The method of claim 19 further comprising storing one or more characteristics associated with the user in the contextual sub-profile for the device, the one or more characteristics being derived from the one or more contextual attributes of the user.

21. The method of claim 18, wherein each of the at least one contextual attribute has a corresponding pre-defined time period.

22. The method of claim 18, wherein the at least two devices are selected from a group comprising a handheld device, a computer, a television, a car screen, a kiosk, a digital photo frame, a touch-screen home gateway, and a digital book.

23. The method of claim 18, wherein the static information comprises at least one of an age, an age group, a gender, one or more preferences, educational qualifications, religion, languages, an ethnicity, an address of the user, professional details, a job profile, a marital status, and an income level.

24. The method of claim 18, wherein the one or more contextual attributes comprise at least one of a time of initiating an interactive session, a time duration of the interactive session, a current location of the user, the device of the at least two devices for initiating the interactive session, a current season, a current state of the user, surrounding events, a content being watched, current activities of the user, and one or more keywords associated with the interactive session.

25. The method of claim 18 further comprising updating the contextual profile after the pre-defined time period.

26. The method of claim 18 further comprising storing the contextual profile in a database.

27. A system for recommending at least one advertisement to a user, the recommendation being provided based on the interaction between the system and at least two devices, the system comprises:
a. a data capturing module configured for dynamically capturing one or more contextual attributes, the one or more contextual attributes being captured from an interactive session initiated by the user on a device of the at least two devices;
b. a recommendation module comprising:
i. a selecting module configured for selecting a contextual profile from a database, the selection performed based on an identity associated with the user, the contextual profile being associated with one or more contextual sub-profiles, each of the one or more contextual sub-profiles being associated with each of the at least two devices;
ii. a mapping module configured for mapping at least one of the contextual profile and the captured one or more contextual attributes with a plurality of pre-stored advertisements; and
iii. a suggestion module configured for suggesting the at least one advertisement on the device based on the mapping.

28. The system of claim 27 further comprising a profile-creation module configured for:
a. creating the contextual sub-profile for each of the at least two devices based on static information and contextual attributes, at least one contextual attribute of the contextual attributes being captured over a pre-defined time period, wherein the contextual attributes are captured across the at least two devices; and
b. creating the contextual profile of the user by collating each of the contextual sub-profile.

29. The system of claim 28, wherein the static information and the contextual attributes are captured by the data capturing module.

30. The method of claim 28, wherein each of the at least one contextual attribute has a corresponding pre-defined time period.

31. The system of claim 28, wherein the profile-creation module further comprises a classification module configured for classifying the user in one or more categories, the user being classified based on the static information and the contextual attributes.

32. The system of claim 28, wherein the profile-creation module is further configured for storing one or more characteristics associated with the user in the contextual sub-profile for the device, the one or more characteristics being derived from the contextual attributes of the user.

33. The system of claim 28, wherein the profile-creation module further comprises an updating module configured for updating the contextual profile after the pre-defined time period.

34. The system of claim 28 further comprising a memory module configured for storing the contextual profile in the database.

35. The system of claim 27, wherein the suggestion module is further configured for suggesting at least one new advertisement based on the suggested at least one advertisement.

36. The system of claim 35, wherein the data capturing module is further configured for capturing dynamic information associated with current activities of the user, the current activities being performed on the suggested at least one advertisement.

37. The system of claim 36, wherein the dynamic information comprises at least one of a survey information associated with the suggested at least one advertisement, a rating information associated with the suggested at least one advertisement, and a pattern of clicks exhibited by the user on the suggested at least one advertisement.

38. The system of claim 36, wherein the suggestion module is further configured for recommending the at least one new advertisement from the plurality of pre-stored advertisements based on the dynamic information.

39. The system of claim 36, wherein the recommendation module further comprises a refreshing module configured for refreshing the contextual profile based on the dynamic information, the refreshing being performed based on a pre-defined criterion.

40. The system of claim 35, wherein the suggestion module is further configured for:
a. identifying a genre associated with the suggested at least one advertisement;
b. identifying one or more other genres, wherein the genre and the one or more other genres are related with at least one of the contextual profile and the one or more contextual attributes associated with the interactive session; and
c. recommending the at least one new advertisement associated with the one or more other genres.

41. A computer program product for use with a computer, the computer program product comprising a computer readable storage medium having a computer readable program code embodied therein for recommending at least one advertisement to a user, the recommendation being provided based on the interaction with at least two devices, the computer readable program code comprising:
a. a program instruction means for identifying the user, the identification being performed when an interactive session is initiated by the user on a device of the at least two devices;
b. a program instruction means for selecting a contextual profile from a database, the contextual profile being selected corresponding to the identified user, the contextual profile being associated with one or more contextual sub-profiles, each of the one or more contextual sub-profiles being associated with each of the at least two devices;
c. a program instruction means for dynamically capturing one or more contextual attributes from the interactive session;
d. a program instruction means for mapping at least one of the contextual profile and the one or more captured contextual attributes with a plurality of pre-stored advertisements; and
e. a program instruction means for suggesting the at least one advertisement on the device based on the mapping.

42. The computer program product of claim 41, wherein the one or more contextual attributes are dynamically captured after a pre-defined time duration of the interactive session.

43. The computer program product of claim 41 further comprising a program instruction means for updating the contextual profile at regular intervals of time based on the one or more contextual attributes associated with the interactive session.

44. The computer program product of claim 41 further comprising a program instruction means for suggesting at least one new advertisement based on the suggested at least one advertisement.

45. The computer program product of claim 44, wherein the program instruction means for suggesting the at least one new advertisement further comprises:
a. a program instruction means for dynamically monitoring current activities of the user, the current activities being associated with the suggested at least one advertisement;
b. a program instruction means for capturing dynamic information associated with the current activities of the user; and
c. a program instruction means for recommending the at least one new advertisement from the plurality of pre-stored advertisements, the at least one new advertisement being recommended based on the dynamic information.

46. The computer program product of claim 45, wherein the contextual profile is updated based on the dynamic information, the updation being performed based on a pre-defined criterion.

47. The computer program product of claim 44, wherein the program instruction means for suggesting the at least one new advertisement further comprises:
a. a program instruction means for identifying a genre associated with the suggested at least one advertisement;
b. a program instruction means for identifying one or more other genres, wherein the genre and the one or more other genres are related with at least one of the contextual profile and the one or more contextual attributes associated with the interactive session; and
c. a program instruction means for recommending the at least one new advertisement associated with the one or more other genres.

48. The computer program product of claim 41 further comprising a program instruction means for preparing the contextual profile for the user, the program instruction means comprising:
a. a program instruction means for capturing static information and contextual attributes associated with the user, at least one contextual attribute of the contextual attributes being captured over a pre-defined time period, wherein the contextual attributes are captured across the at least two devices;
b. a program instruction means for creating the contextual sub-profile for each of the at least two devices based on the static information and the contextual attributes; and
c. a program instruction means for creating the contextual profile of the user by collating each of the contextual sub-profile.

49. The computer program product of claim 48, wherein the program instruction means for creating the contextual sub-profile of the user for the device further comprises a program instruction means for classifying the user in one or more categories, the user being classified based on the static information and the contextual attributes.

50. The computer program product of claim 49 further comprising a program instruction means for storing one or more characteristics associated with the user in the contextual sub-profile for the device, the one or more characteristics being derived from the contextual attributes of the user.

51. The method of claim 48, wherein each of the at least one contextual attribute has a corresponding pre-defined time period.

52. The computer program product of claim 48 further comprising a program instruction means for updating the contextual profile after the pre-defined time period.

53. The computer program product of claim 48 further comprising a program instruction means for storing the contextual profile in the database.
